(19) United States
(12) Patent Application Publication
(10) Pub. No.: US 2017/0134763 A1
(43) Pub. Date: May 11, 2017

(54) METHOD FOR COMPRESSING TRANSMISSION PACKET IN IP-BASED BROADCAST NETWORK

(71) Applicant: SAMSUNG ELECTRONICS CO., LTD., Gyeonggi-do (KR)

(72) Inventors: Sung-Hee HWANG, Suwon-si (KR); Hyun-Koo YANG, Seoul (KR); Ji-Eun KEUM, Suwon-si (KR)

(21) Appl. No.: 15/319,714

(22) PCT Filed: Jun. 19, 2015
(86) PCT No.: PCT/KR2015/006236

§ 371 Date: Dec. 16, 2016

(30) Foreign Application Priority Data
Jun. 20, 2014 (KR) 10-2014-0075871
Jan. 9, 2015 (KR) 10-2015-0003698

(51) Int. Cl. H04N 21/234; H04N 21/643; H04N 21/2383; H04L 29/06; H04N 21/2381

(52) U.S. Cl. CPC H04N 21/234; H04L 69/04; H04N 21/2381; H04N 21/2383; H04N 21/64322

(57) ABSTRACT

The present disclosure relates to a broadcasting method of a transmission apparatus in an IP-based broadcast network, the method comprising: an operation of generating an MPEG media transport protocol (MMTP) packet using a media processing unit (MPU) for a service; an operation of determining an IP session identifier for identifying an IP session for the service, and generating an IP packet using the MMTP packet and the IP session identifier; and an operation of transmitting the generated IP packet in a radio frequency (RF) channel, wherein the IP session identifier maps a combination of a source IP address, a destination IP address and a destination port for the IP packet, and at least one of the IP session identifier, the source IP address, the destination IP address and the destination port is transferred through a first layer signaling.

This application is a National Phase Entry of PCT International Application No. PCT/KR2015/006236, which was filed on Jun. 19, 2015, and claims a priority to Korean Patent Application No. 10-2014-0075871, which was filed on Jun. 20, 2014, and claims a priority to Korean Patent Application No. 10-2015-0003698, which was filed on Jan. 9, 2015, the contents of which are incorporated herein by reference.

### TECHNICAL FIELD

The present disclosure relates to a method and apparatus for transmitting and receiving data in an IP based broadcast telecommunication network, i.e., a method and apparatus for compressing an IP packet for transmission.

### BACKGROUND ART

Internet Protocol (IP) based broadcast telecommunication systems into which communication over broadband networks and radio frequency (RF) based communication are merged are being designed and constructed these days.

With the modern broadcast telecommunication systems, as the propensity to consume high-quality content grows and high-volume content, such as high definition (HD) and ultra high definition (UHD) content increases, data congestion becomes intensified all the more in the network.

Accordingly, a need exists to efficiently design data for transmission in order to efficiently transmit the data in a broadcast telecommunication network.

### DISCLOSURE

### Technical Problem

The present disclosure provides a method for efficiently designing data for transmission in an IP based broadcast telecommunication network.

The present disclosure also provides a method to efficiently use an IP packet for transmission on a broadcast telecommunication protocol.

The present disclosure also provides a specific layered signaling method on the broadcast telecommunication protocol.

The present disclosure also provides operation of a client receiving layer signaling in an IP based broadcast telecommunication network.

The present disclosure also provides a structure of a compressed IP packet for transmission in an IP based broadcast telecommunication network.

### Technical Solution

The present disclosure provides a broadcasting method of a transmission apparatus in an IP-based broadcast network, the method including: generating an MPEG media transport protocol (MMTP) packet using a media processing unit (MPU) for a service; determining an IP session identifier for identifying an IP session for the service, and generating an IP packet using the MMTP packet and the IP session identifier; and transmitting the generated IP packet in a radio frequency (RF) channel, wherein the IP session identifier maps a combination of a source IP address, a destination IP address and a destination port for the IP packet, and at least one of the IP session identifier, the source IP address, the destination IP address and the destination port is transmitted through first layer signaling.

The present disclosure also provides a broadcast receiving method of a client in an IP-based broadcast network, the method including: receiving an RF channel for a service, and decoding a physical layer pipe (PLP) of the RF channel; obtaining an IP session identifier by parsing a first layer signal included in the PLP; obtaining an IP packet corresponding to the service from the PLP using the IP session identifier; and obtaining an MPEG media transport Protocol (MMTP) packet by depacketizing the IP packet, and obtaining a media processing unit (MPU) from the MMTP packet, wherein the IP session identifier maps a combination of a source IP address, a destination IP address and a destination port for the IP packet, and at least one of the source IP address, the destination IP address and the destination port is received through the first layer signaling.

The present disclosure also provides a broadcasting apparatus in an Internet Protocol (IP) based broadcast network, the apparatus including: a controller for generating an MPEG media transport Protocol (MMTP) packet using a Media Processing Unit (MPU) for a service, determining an IP session identifier for identifying an IP session for the service, and generating an IP packet using the MMTP packet and the IP session identifier; and a transceiver for transmitting the generated IP packet in a radio frequency (RF) channel, wherein the IP session information is an identifier for mapping a combination of a source IP address, a destination IP address, and a destination port to the IP packet, and at least one of the IP session identifier, the source IP address, the destination IP address, and the destination port is transmitted through first layer signaling.

The present disclosure also provides a client apparatus in an Internet Protocol (IP) based broadcast network, the apparatus including: a transceiver for receiving an RF channel for a service; and a controller for decoding a Physical Layer Pipe (PLP) of the RF channel, obtaining an IP session identifier by parsing a first layer signal included in the PLP, obtaining an IP packet corresponding to the service from the PLP using the IP session identifier, obtaining an MPEG media transport protocol (MMTP) packet by depacketizing the IP packet, and obtaining a Media Processing Unit from the MMTP packet, wherein the IP session information is an identifier for mapping a combination of a source IP address, a destination IP address, and a destination port to the IP packet, and at least one of the source IP address, the destination IP address, and the destination port is received through first layer signaling.

According to the present disclosure, a broadcast transmission apparatus may compress an IP packet for transmission because it does not have to send a UDP header and IP header of a fixed size for every packet, and as a result, the IP packet decreases in size, which may increase efficiency in use of transmit resources.

### DESCRIPTION OF DRAWINGS

FIG. 1 illustrates a protocol stack according to the present disclosure, which can be applied to an ATSC 3.0 system;

FIGS. 2A, 2B, and 2C are diagrams of the concept of a method for compressing an IP packet according to the present disclosure;

FIG. 3 illustrates L2 signaling sent in one RF channel in RF broadcasting from a perspective of the RF channel;

FIG. 4 illustrates a broadcast receiving method of a client in a first case according to an embodiment of the present disclosure;

FIG. 5 illustrates a broadcast receiving method of a client in a second case according to an embodiment of the present disclosure;

FIG. 6 illustrates a broadcast transmitting method of a broadcast transmission apparatus according to an embodiment of the present disclosure;

FIG. 7 is a block diagram of a client device according to an embodiment of the present disclosure; and

FIG. 8 is a block diagram of a transmission apparatus according to an embodiment of the present disclosure.

### MODE FOR INVENTION

Embodiments of the present disclosure will now be described with reference to accompanying drawings. Descriptions of some well-known technologies that possibly obscure the invention will be omitted, if necessary. Further, terms, as will be mentioned later, are defined by taking functionalities of the present disclosure into account, but may vary depending on certain practices or intentions of users or operators. Accordingly, the definition of the terms should be made based on the descriptions throughout this specification.

Prior to explaining embodiments of the present disclosure, several terms used in this specification will be described first. However, it will be appreciated that those terms are not limited to what will be described below.

A broadcast transmission apparatus is an entity for communicating with a client, which may be referred to as a transmission apparatus, a server, etc.

A client is an entity for communicating with the broadcast transmission apparatus, which may be referred to as a television (TV), a user equipment (UE), a mobile station (MS), a mobile equipment (ME), a device, a terminal, etc.

The term ‘compressed’ herein refers not only to an occasion when a compression algorithm is applied to a packet but also to an occasion when one or more processes result in reduction in length of a packet.

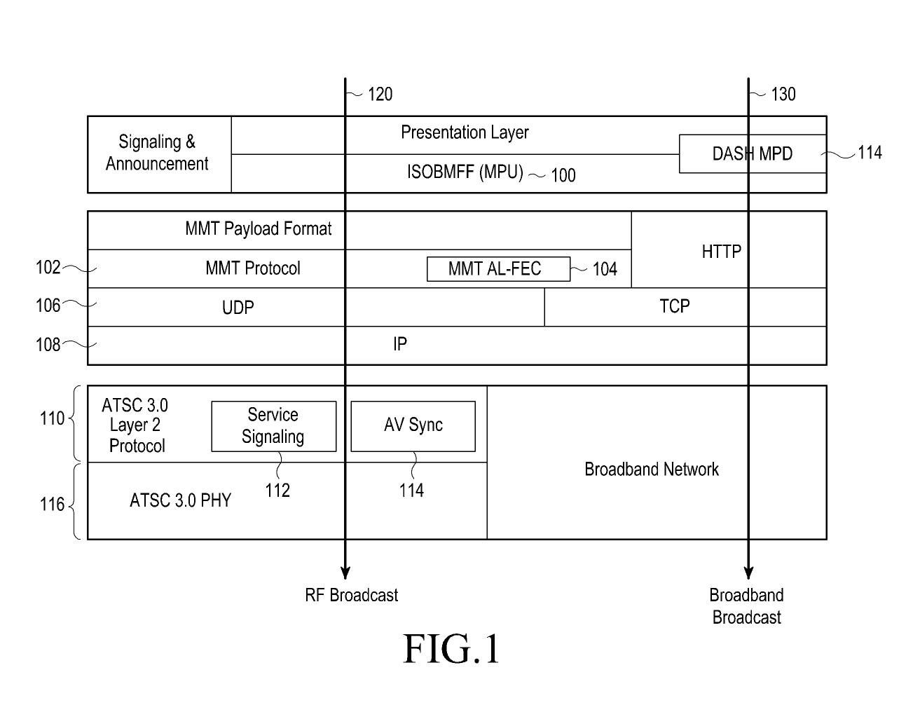

FIG. 1 illustrates a protocol stack according to the present disclosure, which can be applied to an ATSC 3.0 system.

An Advanced Television Systems Committee (ATSC) 3.0 system is a standard system for digital television transmission over terrestrial, cable, satellite networks, etc.

A basic transmission unit, a Media Processing Unit (MPU) 100 which makes up a broadcast content may be in e.g., an ISO base media file format (ISOBMFF). The MPU 100 is processed into an MPEG media transport (MMT) payload format, and may be constructed into an MMT Protocol (MMTP) packet to be sent on an MMTP 102. In the construction process for the MMTP, application layer forward error correction (AL-FEC) encoding may optionally be further performed on the processed MPU.

The MMTP packet is reconstructed into a User Datagram Protocol (UDP) packet 106 with addition of a User Datagram Protocol (UDP) header, and the reconstructed UDP packet may be reconstructed into an IP packet 108 with addition of an IP header.

The IP packet 108 reconstructed in this way may be RF broadcast through a layer 2 (L2) 110 and a physical (PHY) layer 116. The Layer 2 may include a service signal (hereinafter, referred to as an ‘L2 signal’) including an IP session identifier, IP session information, etc., and AV sync information 114 that may be used for content display.

An arrow 120 represents a protocol stack at a transmit end to be RF broadcast. A protocol stack at the transmit end to be broadcast in broadband is represented by an arrow 130. Broadcast content broadcast over the broadband may further include Dynamic Adaptive Streaming over HTTP (DASH) Media Presentation Description (MPD) 114 in addition to the MPU.

Tables 1 to 3 represent structures of the UDP header and IP header.

TABLE 1
UDP Header

| Offsets Octet | | 0 | | | | | | | | 1 | | | | | | | | 2 | | | | | | | |
|---|---|---|---|---|---|---|---|---|---|---|---|---|---|---|---|---|---|---|---|---|---|---|---|---|---|
| Octet | Bit | 0 | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 |

| | | | |
|---|---|---|---|
| 0 | 0 | Source port | Destination port |
| 4 | 32 | Length | Checksum |

| Offsets Octet | | 3 | | | | | | | |
|---|---|---|---|---|---|---|---|---|---|
| Octet | Bit | 24 | 25 | 26 | 27 | 28 | 29 | 30 | 31 |

| | | |
|---|---|---|
| 0 | 0 | Destination port |
| 4 | 32 | Checksum |

TABLE 2
IPv4 Header Format

| Offsets | Octet | 0 | | | | | | | | 1 | | | | | | | |
|---|---|---|---|---|---|---|---|---|---|---|---|---|---|---|---|---|---|
| Octet | Bit | 0 | 1 | 2 | 3 | 4 | 5 | 6 | 7 | 8 | 9 | 10 | 11 | 12 | 13 | 14 | 15 |
| 0 | 0 | Version | | | | II-IL | | | | DSCP | | | | | | DCN | |
| 4 | 32 | Identification | | | | | | | | | | | | | | | |
| 8 | 64 | Time to Live | | | | | | | | Protocol | | | | | | | |
| 12 | 96 | Source IP Address | | | | | | | | | | | | | | | |
| 16 | 128 | Destination IP Address | | | | | | | | | | | | | | | |
| 20 | 160 | Options (if 1HL >5) | | | | | | | | | | | | | | | |
| Offsets | Octet | 2 | | | | | | | | 3 | | | | | | | |
| Octet | Bit | 16 | 17 | 18 | 19 | 20 | 21 | 22 | 23 | 24 | 25 | 26 | 27 | 28 | 29 | 30 | 31 |

| 0 | 0 | Total Length | |
|---|---|---|---|
| 4 | 32 | Flags | Fragment Offset |

| | | |
|---|---|---|
| 8 | 64 | Header Checksum |
| 12 | 96 | Source IP Address |
| 16 | 128 | Destination IP Address |
| 20 | 160 | Options (if 1HL >5) |

TABLE 3
Fixed header format

| Offsets | Octet | 0 | | | | | | | | 1 | | | | | | | |
|---|---|---|---|---|---|---|---|---|---|---|---|---|---|---|---|---|---|
| Octet | Bit | 0 | 1 | 2 | 3 | 4 | 5 | 6 | 7 | 8 | 9 | 10 | 11 | 12 | 13 | 14 | 15 |
| 0 | 0 | Version | | | | Traffic Class | | | | | | | | | | | |
| 4 | 32 | Payload Length | | | | | | | | | | | | | | | |
| 8 | 64 | Source Address | | | | | | | | | | | | | | | |
| 12 | 96 | | | | | | | | | | | | | | | | |
| 16 | 128 | | | | | | | | | | | | | | | | |
| 20 | 160 | | | | | | | | | | | | | | | | |
| 24 | 192 | Destination Address | | | | | | | | | | | | | | | |
| 28 | 224 | | | | | | | | | | | | | | | | |
| 32 | 256 | | | | | | | | | | | | | | | | |
| 36 | 288 | | | | | | | | | | | | | | | | |
| Offsets | Octet | 2 | | | | | | | | 3 | | | | | | | |
| Octet | Bit | 16 | 17 | 18 | 19 | 20 | 21 | 22 | 23 | 24 | 25 | 26 | 27 | 28 | 29 | 30 | 31 |

| 0 | 0 | Flow Label | |
|---|---|---|---|
| 4 | 32 | Next Header | Hop Limit |

| | | |
|---|---|---|
| 8 | 64 | Source Address |
| 12 | 96 | |
| 16 | 128 | |
| 20 | 160 | |
| 24 | 192 | Destination Address |
| 28 | 224 | |
| 32 | 256 | |
| 36 | 288 | |

Table 1 represents a structure of a UDP header, Table 2 represents a structure of an IP header in the case of IP version 4 (IPv4), and Table 3 represents a structure of an IP header in the case of IP version 6 (IPv6). Referring to Tables 1 to 3, the UDP header has a size of 8 bytes, and the IP header has a size of 20 bytes (IPv4) or 40 bytes (IPv6).

For example, in a case that content of a size of 10,000 bytes is RF broadcast, if the content of 10,000 bytes is transmitted in MMTP packets, each MMTP packet being 1,000 byte long, 10 MMTP packets are transmitted. The 10 MMTP packets created from the content may have the same source IP address, destination IP address, and destination port.

Accordingly, for content of a large size, spaces for the UDP header and IP header included in many MMTP packets overlap to include the same information (source IP address, destination IP address, and destination port), which hinders efficient use of resources.

Accordingly, the present disclosure proposes a scheme for the IP packets to be broadcast to include not UDP header and IP header but information for identifying an IP session (distinguished by the source IP address, destination IP address, and destination port). The information for identifying the IP session may be sent through signaling of other layer (which means a predetermined layer, called hereinafter a ‘first layer’) sent at regular intervals. According to the present disclosure, a broadcast transmission apparatus may compress an IP packet for transmission because it does not need to send a UDP header and IP header of a fixed size for each packet, and as a result, the IP packet decreases in size, which may increase efficiency in use of transmit resources.

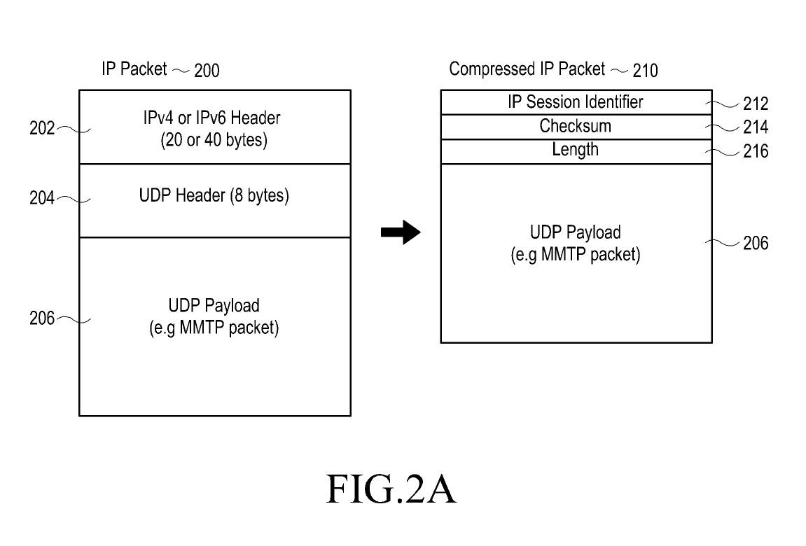

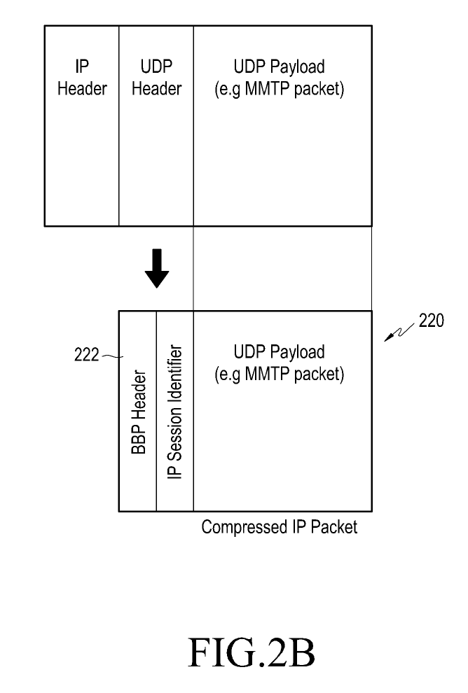

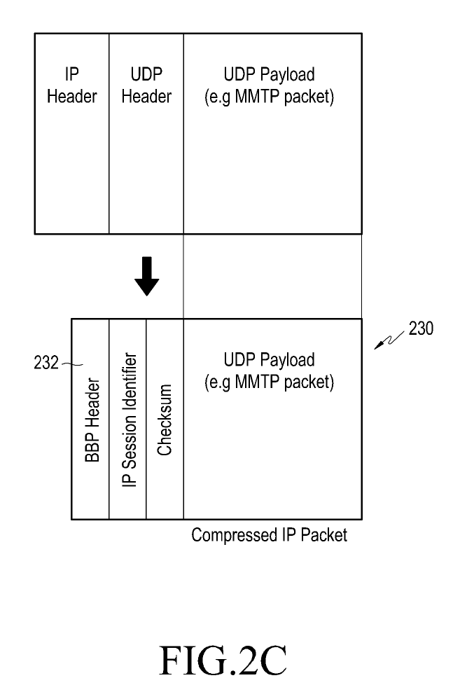

FIGS. 2A, 2B, and 2C are diagrams of the concept of a method for compressing an IP packet according to the present disclosure.

In FIG. 2A, a normal IP packet 200 further includes an UDP header 204 having a size of 8 bytes and an IP header 202 having a size of 20 or 40 bytes in addition to a UDP payload 206.

In FIG. 2A, a compressed IP packet 210 according to the present disclosure does not include the conventional UDP header and IP header. The compressed IP packet 210 may include an IP session identifier 212 in the header, in addition to the UDP payload 206. The UDP payload 206 may be, for example, an MMTP packet. The IP session identifier 212 is information for identifying an IP session distinguished by the source IP address, destination IP address, and destination port, and may be represented in 8 bits. In other words, for IP packets in the same IP session, an IP session identifier of the same value is set in the header of the compressed IP packet.

Mapping information of the IP session and the IP session identifier, i.e., information of an IP session indicated by the IP session identifier (i.e., a source IP address, destination IP address, and destination port) may be sent through signaling (arbitrary layer, e.g., Layer 2) of other layer. The information of the IP session may further include the same (i.e., common) values among pieces of information of the UDP/IP packet header about the IP packets, apart from the source IP address, destination IP address, and destination port. If the same values (common in the IP packets) are operated as one value in all for all IP sessions, and the transmission apparatus and receiving apparatus share or know in advance the same value based on mutual agreement (e.g., a predetermined value agreed in a standard), the same value may not be transmitted.

The first layer signaling may be e.g., L2 signaling of an ATSC system, higher layer signaling (e.g., signaling of Layer 3, such as MMT layer or service layer), or signaling of Layer 1 (L1) such as PHY layer. For example, the information of the IP session indicated by the IP session identifier may be generated in the Layer 3 (L3) and sent through Layer 2 (L2) signaling. The Layer 2 (L2) of the ATSC system may be a layer for interfacing a layer higher than the IP layer and the PHY layer, and may also be referred to as a link layer.

Optionally, the compressed IP packet may further include at least one of checksum information 214 and length information 216.

The checksum information 214 has a value used for checking integrity of the UDP payload 206, and a broadcast receiving apparatus may check the integrity of received data with the checksum. Optionally, the checksum information may reuse a checksum value intact that was included in the UDP header of a normal IP packet, and may be in 16 bits.

Optionally, the checksum information may be omitted if reliability of data reconstructed in the PHY layer is fully secured.

The length information 216 is information about a length used by the broadcast receiving apparatus in receiving an IP packet. The length information may represent a total length of the compressed IP packet, or represent a length of the UDP payload 206. Optionally, the length information may reuse a length value that was included in the UDP header of a normal IP packet as it is, and may be in e.g., 16 bits.

FIGS. 2B and 2C show examples 220, 230 of a compressed IP packet with no length information according to the present disclosure.

As shown in FIGS. 2B and 2C, a compressed IP packet is applied for a baseband packet (BBP), the compressed IP packet 220, 230 omits the length information of the compressed IP packet illustrated in FIG. 2A because the BBP packet includes the length information. In other words, the length information may be sent in the header 222, 232 of the BBP packet sent in the compressed IP packet.

Other fields of normal UDP header and IP header included in Tables 1 to 3 may optionally be further included as necessary.

Transmission of the IP session identifier and IP session information in L2 signaling will now be described in detail.

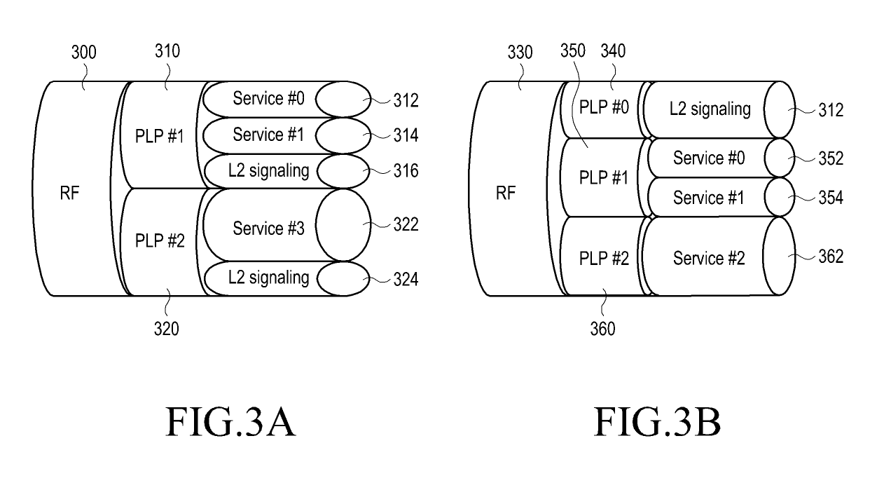

FIG. 3 illustrates L2 signaling sent in one RF channel in RF broadcasting from a perspective of the RF channel.

In FIG. 3, it is assumed that the broadcast receiving apparatus (or client) has already completed initial scanning of RF broadcasting. Accordingly, it is assumed that the client has already been informed of an electronic program guide (EPG), and if the user chooses a particular TV channel, the client already knows of an RF channel and physical layer pipe (PLP) number mapped to the TV channel. The TV channel corresponds to a logical channel. For example, a service of TV channel i may be transmitted from RF channel k's PLP number j.

The service may correspond to an MMT standard package, or a label, or a TV channel. The TV channel may correspond to a substream of a PLP or baseband packet (BBP). An RF channel broadcast from an ATSC 3.0 system may have e.g., a band of 6 MHz and include multiple logical channels (i.e., services).

FIG. 3A illustrates a first case where L2 signals are sent from the respective PLPs included in the RF channel.

An RF channel 300 includes two PLPs 310, 320. The PLPs 310, 320 may be allocated to e.g., TV broadcasting companies, such as National Broadcasting Company (NBC), Columbia Broadcasting System (CBS), American Broadcasting Company (ABC). The PLPs 310, 320 may each transmit at least one service 312, 314, 322, and the service may correspond to a TV channel. The two PLPs 310, 320 each transmit L2 signaling information 316, 324. That is, an L2 signal may be transmitted for each PLP.

FIG. 3B illustrates a second case where an L2 signal is sent from an arbitrary PLP for all of the multiple PLPs included in the RF channel.

An RF channel 330 includes three PLPs 340, 350, 360. A PLP 340 among the PLPs 340, 350, 360 is used to transmit the L2 signal for all the PLPs 340, 350, 360 included in the RF channel 330. That is, a particular PLP 340 transmits the L2 signal for all the services included in the RF channel. The PLPs 350, 360 may each transmit at least one service 352, 354, 362.

The L2 signaling information 316, 324, 342 illustrated in FIGS. 3A and 3B may be sent with mapping information of the IP session identifier and IP session proposed in the present disclosure.

Table 4 represents L2 signaling information transmitted in the first case.

TABLE 4

| | |
|---|---|
| Number_of_package | N1 |
| For (i=0;i<N1;i+ + ){ | |
| Package_id | |
| Label | |
| Number_of_IP_session | N2 |
| For (j=0;j<N2;j+ + ){ | |
| Compression Flag (1bit) | |
| IP version (4bits) | |
| Reserved (3bits) | |
| IP Session Identifier (8bits) | |
| Source IP Address (32bits or 128bits) | |
| Destination IP Address (32bits or 128bits) | |
| Destination Port# (16bits) | |
| Number_of_components | N3 |
| For (k=0;k<N3;+ + k) { | |
| Component_PID | |
| Component_type | |
| Main_flag { | |
| MPU_seq_num | |
| MPU_start_time | |
| } | |
| } | |
| } | |
| } | |

Since the L2 signal is sent for each PLP in the first case, the L2 signal needs to identify IP session information for the entire services included in the PLP. The services are the concept corresponding to packages in the case of the MMT standard, and Table 4 represents that ‘Number_of_package’ describes all the services.

As illustrated in Table 4, the L2 signaling information may include ‘IP session Identifier’ corresponding to the number of IP sessions.

The client receiving the L2 signaling may then be aware of what IP session is mapped to the IP session identifier by using ‘Source IP Address’, ‘Destination IP Address’ and ‘Destination Port’ included with the IP session identifier. The IP session identifier may be represented in e.g., 8 bits, in which case 256 (=2⁸) IP sessions may be distinguished using the IP session identifier. The number of bits to represent the IP session identifier may be properly modified according to implementations.

Optionally, the L2 signaling information may further include a ‘Compression Flag’ of 1 bit. The Compression Flag is information for transmission to indicate whether the IP packet for transmission is a normal IP packet or a compressed IP packet.

Optionally, the L2 signaling information may further include an ‘IP version’. The IP version is information used to indicate whether the version of the IP packet for transmission is IPv4 or IPv6.

Table 5 represents L2 signaling information transmitted in the second case.

TABLE 5

| | |
|---|---|
| Number of PLPs { | N0 |
| Number_of_package | N1 |
| For (i=0;i<N1;i+ + ){ | |
| Package_id | |
| Label | |
| Number_of_IP_session | N2 |
| For (j=0;j<N2;j+ + ){ | |
| Compression Flag (1bit) | |
| IP version (4bits) | |
| Reserved (3bits) | |
| IP Session Identifier (8bits) | |
| Source IP Address (32bits or 128bits) | |
| Destination IP Address (32bits or 128bits) | |
| Destination Port# (16bits) | |
| Number_of_components | N3 |
| For (k=0;k<N3;+ + k) { | |
| Component_PID | |
| Component_type | |
| Main_flag { | |
| MPU_seq_num | |
| MPU_start_time | |
| } | |
| } | |
| } | |
| } | |
| } | |

Since an L2 signal is sent for each RF channel in the second case, the L2 signal needs to identify IP session information for all the services included in all the PLPs of the RF channel. The services are the concept corresponding to packages in the case of the MMT standard, and Table 5 represents that ‘Number of PLPs’ describes all the PLPs of the RF channel.

As illustrated in Table 5, the L2 signaling information may include ‘IP session Identifier’ corresponding to the number of IP sessions.

The client receiving the L2 signaling may then be aware of what IP session is mapped to the IP session identifier by using ‘Source IP Address’, ‘Destination IP Address’ and ‘Destination Port’ included with the IP session identifier. The number of bits to represent the IP session identifier may be properly modified according to implementations.

Optionally, the L2 signaling information may further include a ‘Compression Flag’ of 1 bit. The Compression Flag is information for transmission to indicate whether the IP packet for transmission is a normal IP packet or a compressed IP packet.

Optionally, the L2 signaling information may further include an ‘IP version’. The IP version is information used to indicate whether the version of the IP packet for transmission is IPv4 or IPv6.

Optionally, the IP session information may further include one(s) of pieces of the UDP/IP packet header information of IP packets, which has(have) the same (i.e., common) value(s), in addition to the source IP address, destination IP address, and destination port, in the case that the Compression Flag indicates a compressed IP packet in Tables 4 and 5. However, if the same (i.e., common) values are operated as one value in all for all IP sessions, and mutual agreements between the transmission apparatus and the receiving apparatus (e.g., mutual agreements on a predetermined value in a standard) are set up, the common value may not be included.

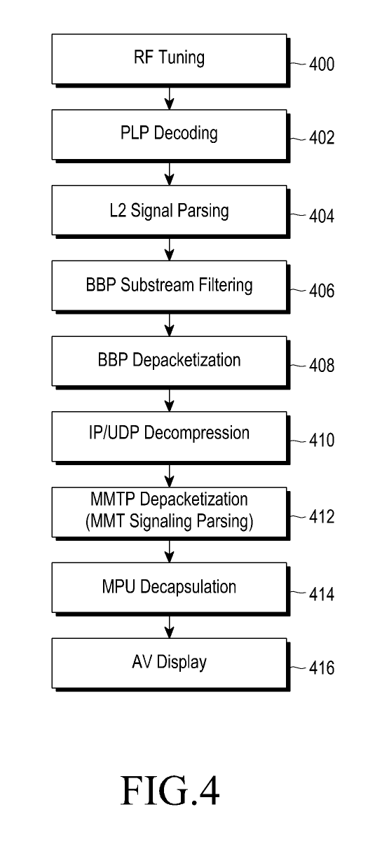

FIG. 4 illustrates a broadcast receiving method of a client in a first case according to an embodiment of the present disclosure.

The client RF tunes to a TV channel (if the TV channel is selected by the user), in operation 400.

The client decodes a PLP corresponding to the selected TV channel, in operation 402.

The client obtains IP session information for the selected TV channel by parsing the L2 signal sent in the PLP, in operation 404. The IP session information may include a source IP address, destination IP address, and destination port of IP session information mapped to the IP session identifier.

The client filters a BBP substream corresponding to the selected TV channel from the decoded PLP, in operation 406. Specifically, the client may filter the BBP substream corresponding to the TV channel by checking a label written in the BBP header. Optionally, the client may perform filtering using the IP session information (source IP address, destination IP address, destination port).

The client obtains an IP packet or UDP packet by depacketizing the filtered BBP, in operation 408. Specifically, if the IP packet is compressed, the client may figure out IP session information mapped to the IP session identifier, and decompress the IP packet or UDP packet with the IP session information to obtain an IP packet or UDP packet. The client obtains an MMTP packet by depacketizing the obtained IP packet or UDP packet, in operation 410.

The client obtains an MPU by depacketizing the MMTP packet, in operation 412. Optionally, the client may further perform parsing operation on an MMT signal.

The client obtains content data by decapsulating the MPU, in operation 414.

The client performs AV display using at least one of the MMT signal and audio video (AV) sync information sent in L2 signaling, and the obtained content data, in operation 416. The MMT signal may be e.g., MMT composition information (MMT-CI).

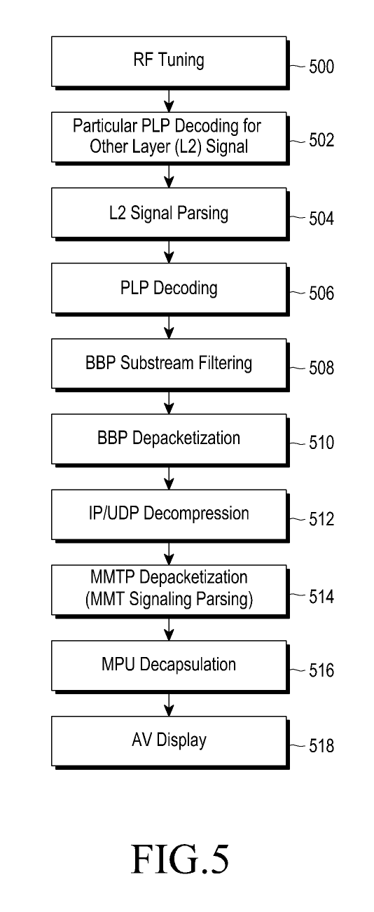

FIG. 5 illustrates a broadcast receiving method of a client in a second case according to an embodiment of the present disclosure.

The client RF tunes to a TV channel (if the TV channel is selected by the user), in operation 500.

The client decodes a particular PLP included in the RF to obtain L2 signaling information, in operation 502.

The client obtains IP session information for the selected TV channel by parsing the L2 signal included in the particular PLP, in operation 504.

The client decodes a PLP corresponding to the selected TV channel, in operation 506.

The client filters a BBP substream corresponding to the selected TV channel from the decoded PLP, in operation 508. Specifically, the client may filter the BBP substream corresponding to the TV channel by checking a label written in the BBP header. Optionally, the client may perform filtering using the IP session information (source IP address, destination IP address, destination port).

The client obtains an IP packet or UDP packet by depacketizing the filtered BBP, in operation 510. Specifically, if the IP packet is compressed, the client figures out IP session information mapped to the IP session identifier, and decompress the IP packet or UDP packet with the IP session information to obtain an IP packet or UDP packet. The client obtains an MMTP packet by depacketizing the IP packet or UDP packet, in operation 512.

The client obtains an MPU by depacketizing the MMTP packet, in operation 514. Optionally, the client may further perform parsing operation on an MMT signal.

The client obtains content data by decapsulating the MPU, in operation 516.

The client performs AV display using at least one of the MMT signal and AV sync information sent in L2 signaling, and the obtained content data, in operation 518. The MMT signal may be e.g., MMT-CI.

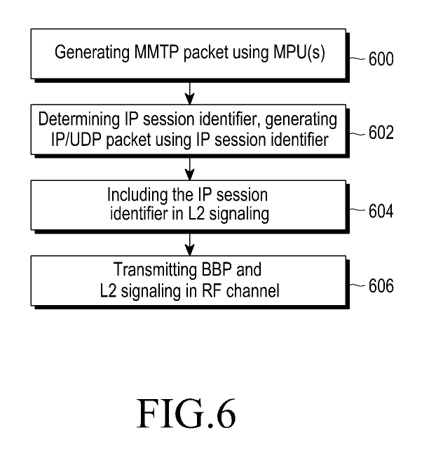

FIG. 6 illustrates a broadcast transmitting method of a broadcast transmission apparatus according to an embodiment of the present disclosure.

The transmission apparatus generates an MMTP packet using at least one MPU for a particular service (e.g., a TV channel), in operation 600.

The transmission apparatus determines an IP session identifier to identify an IP session for the service, and generates a compressed IP packet by including the IP session identifier in the MMTP packet (without including the conventional UDP header or IP header), in operation 602. Optionally, the compressed packet may further include checksum information for checking integrity. Optionally, the compressed packet may further include length information to indicate a length of the IP packet or the MMTP packet.

The transmission apparatus may include the IP session identifier in the L2 signaling, in operation 604.

The transmission apparatus generates a BBP substream using the IP packet or UDP packet, generates a PLP by PHY layer encoding of the L2 signal and the BBP substream, and broadcasts the generated PLP in the RF channel, in operation 608. Optionally, the BBP header included in the IP packet may include information to distinguish whether the IP packet is compressed or not. For example, a non-compressed IP packet and a compressed IP packet may be distinguished by a value (e.g., 0 or 1) of the type field for indicating what type the payload of the BBP packet has. The length information of the compressed IP packet may be indicated by the length information of the BBP header. In this case, the compressed IP packet may not include length information.

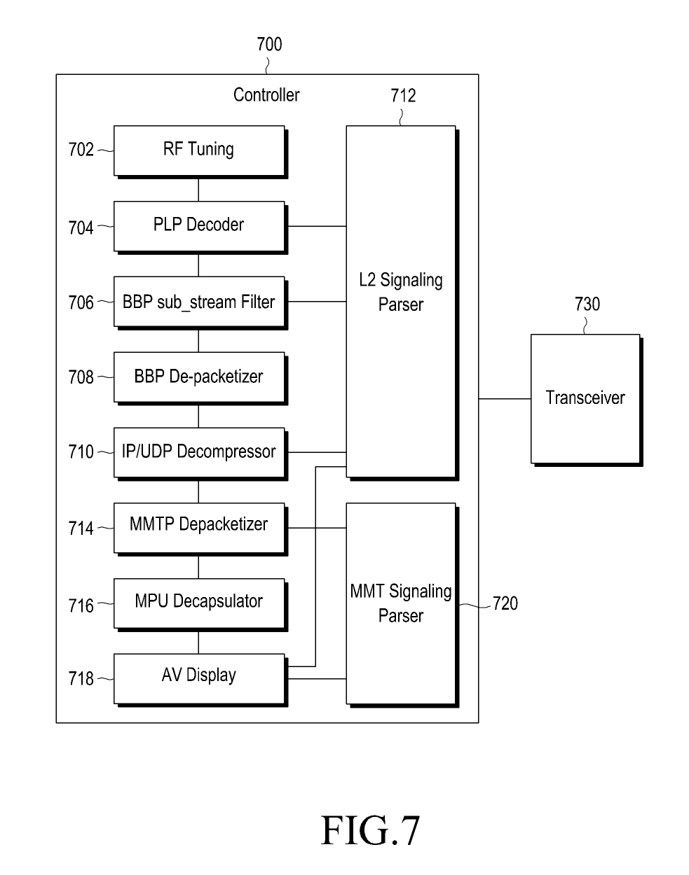

FIG. 7 is a block diagram of a client device according to an embodiment of the present disclosure.

The client device of FIG. 7 is a device for performing operations of the client as described in the present disclosure. The client device may perform a broadcast receiving method described in e.g., FIGS. 4 and 5.

The client device may include a transceiver 730 for receiving various signals broadcast from the broadcast transmission apparatus, and a controller 700 for controlling the transceiver 730 and processing the received various signals. Although shown in separate modules, the transceiver 730 and the controller 700 may be implemented in a single device.

The controller 700 may be understood as performing operation of the client as described in the present disclosure.

For example, the controller 700 may include various submodules 702 to 720 as will be described below, but may also be implemented in a single module.

In response to an input of a TV channel from the user, an RF tuner 70 performs RF tuning to the TV channel.

A DLP decoder 704 may perform PLP decoding corresponding to the RF channel (in a first case), and may decode a particular PLP for L2 signaling (in a second case).

An L2 signaling parser 712 may obtain IP session information for the TV channel by parsing an L2 signal from the decoded PLP, and send the parsed L2 signal to a BBP substream filter 706, an IP/UDP decompressor 710, or an AV display 718.

The BBP substream filter 706 filters the BBP substream corresponding to the TV channel by checking a label of the BBP header. Optionally, the BBP substream filter 706 may use IP session information in the filtering operation.

A BBP depacketizer 708 obtains an IP packet or UDP packet by depacketizing the filtered BBP. Optionally, whether a packet after the BBP depacketization (i.e., depacketized BBP packet) is a normal (i.e., non-compressed) IP packet or a compressed IP packet may be distinguished by the type field of the BBP header in the IP packet.

If the packet after the BBP depacketization is a compressed IP packet, the IP/UDP decompressor 710 obtains an MMTP packet by decompressing the IP packet or UDP packet. The IP/UDP decompressor 710 may use the IP session information mapped to the IP session identifier in decompressing the IP packet or UDP packet.

The MMTP depacketizer 714 obtains an MPU by depacketizing the MMTP packet.

The MMT signaling parser 720 may parse the MMT signal and send the result to the AV display 718. The MMT signal may be e.g., MMT composition information (MMT-CI).

The MPU decapsulator 716 obtains content data by decapsulating the MPU.

The AV display 718 performs AV display using at least one of the MMT signal and AV sync information sent in L2 signaling, and the obtained content data.

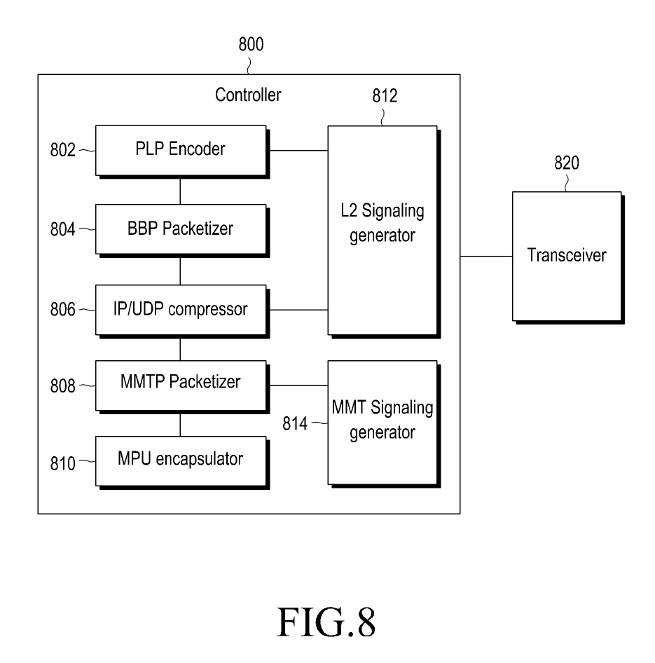

FIG. 8 is a block diagram of a transmission apparatus according to an embodiment of the present disclosure.

The transmission apparatus of FIG. 8 is a device for performing operations of the broadcast transmission apparatus as described in the present disclosure. The transmission apparatus may perform a broadcast receiving method described in e.g., FIG. 6.

The transmission apparatus may include a transceiver 820 for broadcasting various signals to a client, and a controller 800 for controlling the transceiver 820 and processing the various signals. Although shown in separate modules, the transceiver 820 and the controller 800 may be implemented in a single device.

The controller 800 may be understood as performing operation of the broadcast transmission apparatus as described in the present disclosure.

For example, the controller 800 may include various submodules 802 to 814 as will be described below, but may also be implemented in a single module.

An MPU encapsulator 810 generates an MPU using content data corresponding to a particular TV channel.

An MMTP packetizer 808 generates an MMTP packet using the generated MPU. Optionally, an MMT signal sent from an MMT signaling generator 814 may be used in generating the MMTP packet. For example, the MMT signal may include MMT-CI.

An MMT signaling generator 814 may generate pieces of information, such as MMT-CI, and send them to the MMTP packetizer 808.

An L2 signaling generator 812 may determine an IP session identifier for identifying an IP session for a particular service (e.g., a TV channel), generate an L2 signal, and send the IP session identifier to an IP/UDP compressor 806 or a PLP encoder 802.

The IP/UDP compressor 806 generates a compressed IP/UDP packet by including the IP session identifier in the MMTP packet. Optionally, the compressed packet may further include checksum information for checking integrity. Optionally, the compressed packet may further include length information to indicate a length of the IP packet or the MMTP packet.

The BBP packetizer 804 generates a baseband packet (BBP) using the compressed IP/UDP packet. Optionally, the BBP packetizer 804 may set information distinguished from a normal IP/UDP packet in the type filed included in the BBP header to represent that a compressed IP/UDP packet is included. The length information of the compressed IP/UDP packet may be indicated by the length information of the BBP header (length information included in the BBP header). If the length information of the compressed IP packet is indicated by the length information of the BBP header, the compressed IP packet may not include extra length information.

The PLP encoder 802 generates a PLP by PHY layer encoding of an L2 signal or substream of the BBP.

The transceiver 820 broadcasts the generated PLP in the RF channel.

While the present disclosure was described by focusing on L2 layer transmission of IP session information in IP compression, the IP session information may be transmitted through upper layer signaling, such as MMT signaling and service signaling, and may be transmitted through PHY layer signaling or other signaling, apart from the L2 layer. Furthermore, it should be noted that if an IP session identifier and corresponding IP session information are agreed between the transmission apparatus and the receiving apparatus (e.g., if mapping information of the IP session information and IP session identifier is provided on a standard basis, and the transmission apparatus and the receiving apparatus operate according to what is defined by the standard), the IP session information may not be actually transmitted.

It should be noted that the protocol stack, the compressed IP packet structure, the RF channel structure, the broadcast receiving method of a client, the transmitting method of a broadcast transmission apparatus, the client, and the transmission apparatus shown in FIGS. 1 to 8 are not intended to limit the scope of the present disclosure. In this respect, all the layers, PLPs, components or operations illustrated in FIGS. 1 to 8 should not be interpreted as essential elements to implement the present invention, and more or fewer of them may be used to implement the present invention within the scope of the present disclosure.

The foregoing operations may be implemented by program codes stored in a storage equipped in a server, transmission apparatus, and client of a communication system. In other words, the controller of the server, transmission apparatus, and client may perform the foregoing operations by reading out and executing the program codes with a processor or the Central Processing Unit (CPU).

Various components and modules of the server, transmission apparatus, and client may be implemented in hardware, such as Complementary Metal Oxide Semiconductor (CMOS)-based logic circuits, firmware, software, or a combination thereof. For example, various electronic structures and methods may be practiced using electrical circuits, such as transistors, logic gates, and Application Specific Integrated Circuits (ASICs).

Several embodiments have thus been described, but it will be understood that various modifications can be made without departing the scope of the present disclosure. Thus, it will be apparent to those ordinary skilled in the art that the disclosure is not limited to the embodiments described, but can encompass not only the appended claims but the equivalents.

1. A broadcasting method of a transmission apparatus in an Internet Protocol (IP) based broadcast network, the method comprising:
generating an MPEG media transport protocol (MMTP) packet using a media processing unit (MPU) for a service;
determining an IP session identifier for identifying an IP session for the service, and generating an IP packet using the MMTP packet and the IP session identifier; and
transmitting the generated IP packet in a radio frequency (RF) channel,
wherein the IP session identifier is an identifier for mapping a combination of a source IP address, a destination IP address, and a destination port to the IP packet, and at least one of the IP session identifier, the source IP address, the destination IP address, and the destination port is transmitted through first layer signaling.

2. The method of claim 1, wherein the first layer signaling further comprises at least one of pieces of length information indicating a length of the IP packet or the MMTP packet, and checksum information for checking integrity of the IP packet.

3. The method of claim 1, wherein the first layer signaling is Layer 2 signaling of an Advanced Television Systems Committee (ATSC) system.

4. The method of claim 1, wherein the first layer signaling is transmitted for each Physical Layer Pipe (PLP) included in the RF channel.

5. The method of claim 1, wherein the first layer signaling is transmitted in one of Physical Layer Pipes (PLPs) included in the RF channel.

6. A broadcast receiving method of a client in an Internet Protocol (IP) based broadcast network, the method comprising:
receiving an RF channel for a service, and decoding a physical layer pipe (PLP) of the RF channel;
obtaining an IP session identifier by parsing a first layer signal included in the PLP;
obtaining an IP packet corresponding to the service from the PLP using the IP session identifier; and
obtaining an MPEG media transport Protocol (MMTP) packet by depacketizing the IP packet, and obtaining a media processing unit (MPU) from the MMTP packet,
wherein the IP session identifier is an identifier for mapping a combination of a source IP address, a destination IP address, and a destination port to the IP packet, and at least one of the source IP address, the destination IP address, and the destination port is received through first layer signaling.

7. The method of claim 6, wherein the first layer signaling further comprises at least one of pieces of length information indicating a length of the IP packet or the MMTP packet, and checksum information for checking integrity of the IP packet.

8. The method of claim 6, wherein the first layer signaling is Layer 2 signaling of an Advanced Television Systems Committee (ATSC) system.

9. The method of claim 6, wherein the first layer signaling is received for each PLP included in the RF channel.

10. The method of claim 6, wherein the first layer signaling is received through one of PLPs included in the RF channel.

11. A broadcasting apparatus in an Internet Protocol (IP) based broadcast network, the apparatus comprising:
a controller for generating an MPEG media transport Protocol (MMTP) packet using a Media Processing Unit (MPU) for a service, determining an IP session identifier for identifying an IP session for the service, and generating an IP packet using the MMTP packet and the IP session identifier; and
a transceiver for transmitting the generated IP packet in a radio frequency (RF) channel,
wherein the IP session identifier is an identifier for mapping a combination of a source IP address, a destination IP address, and a destination port to the IP packet, and at least one of the IP session identifier, the source IP address, the destination IP address, and the destination port is transmitted through first layer signaling.

12. The apparatus of claim 11, wherein the first layer signaling further comprises at least one of pieces of length information indicating a length of the IP packet or the MMTP packet, and checksum information for checking integrity of the IP packet.

13. The apparatus of claim 11, wherein the first layer signaling is Layer 2 signaling of an Advanced Television Systems Committee (ATSC) system.

14. The apparatus of claim 11, wherein the first layer signaling is transmitted for each Physical Layer Pipe (PLP) included in the RF channel.

15. The apparatus of claim 11, wherein the first layer signaling is transmitted in one of Physical Layer Pipes (PLPs) included in the RF channel.

16. A client apparatus in an Internet Protocol (IP) based broadcast network, the apparatus comprising:
a transceiver for receiving an RF channel for a service; and
a controller for decoding a Physical Layer Pipe (PLP) of the RF channel, obtaining an IP session identifier by parsing a first layer signal included in the PLP, obtaining an IP packet corresponding to the service from the PLP using the IP session identifier, obtaining an MPEG media transport protocol (MMTP) packet by depacketizing the IP packet, and obtaining a Media Processing Unit from the MMTP packet,
wherein the IP session identifier is an identifier for mapping a combination of a source IP address, a destination IP address, and a destination port to the IP packet, and at least one of the source IP address, the destination IP address, and the destination port is received through first layer signaling.

17. The apparatus of claim 16, wherein the first layer signaling further comprises at least one of pieces of length information indicating a length of the IP packet or the MMTP packet, and checksum information for checking integrity of the IP packet.

18. The apparatus of claim 16, wherein the first layer signaling is Layer 2 signaling of an Advanced Television Systems Committee (ATSC) system.

19. The apparatus of claim 16, wherein the first layer signaling is received for each PLP included in the RF channel.

20. The apparatus of claim 16, wherein the first layer signaling is received through one of PLPs included in the RF channel.
